(19) United States
(12) Patent Application Publication
(10) Pub. No.: US 2026/0086270 A1
(43) Pub. Date: Mar. 26, 2026

(54) GLASS MEMBER

(71) Applicant: NIPPON ELECTRIC GLASS CO., LTD., Otsu-shi, Shiga (JP)

(72) Inventors: Takumi KINOSHITA, Otsu-shi (JP); Naoki FUJITA, Otsu-shi (JP)

(21) Appl. No.: 19/110,935

(22) PCT Filed: Oct. 26, 2023
(86) PCT No.: PCT/JP2023/038656

§ 371 Date: Mar. 12, 2025

(30) Foreign Application Priority Data
Oct. 31, 2022 (JP) 2022-174160

(51) Int. Cl. G02B 1/18

(52) U.S. Cl. CPC G02B 1/18

(57) ABSTRACT

Provided is a glass member having excellent water repellency. A glass member 1 with a surface 1a at least partially having ruggedness, wherein when in a region of 96 μm×72 μm of the surface 1a having the ruggedness a mean plane of the ruggedness is a reference plane, a number of convex portions having a height of 50 nm or more from the reference plane is not less than 10 and not more than 250, and when in a micro region of 5 μm×5 μm of the surface 1a having the ruggedness a cutoff value of a high-pass filter λc is 2.5 μm, an arithmetical mean height Sa is not less than 1.0 nm and not more than 50.0 nm.

### TECHNICAL FIELD

The present invention relates to glass members having water repellency.

### BACKGROUND ART

Cameras for use outdoors, including vehicle-mounted cameras and monitoring cameras, are required to prevent water drops from adhering to the camera surfaces and thus provide clear images even if it rains. For this reason, highly water-repellent glass members are required as lens members and cover members of the cameras for use outdoors. As seen from this, there have recently been increasing demands for highly water-repellent glass members.

Patent Literature 1 below discloses a water-repellent washing structure for a vehicle light front lens in which a wash fluid injection nozzle is disposed in front of the front lens and includes an ejection hole formed to pressure eject a wash fluid toward the surface of the front lens and the surface of the front lens is coated with a fluorine-based or silicone-based resin.

### CITATION LIST

### Patent Literature

[PTL 1]
JP-A-H06-330363

### SUMMARY OF INVENTION

### Technical Problem

However, in many cases, when, as in Patent Literature 1, a coating made of an organic fluorine compound or others is formed on the surface of a glass member, the formed coating is very thin and, thus, may be worn or detached by friction due to rubbing or so on. Therefore, it may be difficult that the glass member maintains high water repellency over a long period of time.

An object of the present invention is to provide a glass member having excellent water repellency.

### Solution to Problem

A description will be given of aspects of a glass member that can solve the above problem.

A glass member of aspect 1 in the present invention is a glass member with a surface at least partially having ruggedness, wherein when in a region of 96 μm×72 μm of the surface having the ruggedness a mean plane of the ruggedness is a reference plane, a number of convex portions having a height of 50 nm or more from the reference plane is not less than 10 and not more than 250, and when in a micro region of 5 μm×5 μm of the surface having the ruggedness a cutoff value of a high-pass filter λc is 2.5 μm, an arithmetical mean height Sa is not less than 1.0 nm and not more than 50.0 nm.

A glass member of aspect 2 in the present invention is a glass member with a surface at least partially having ruggedness, wherein when in a region of 96 μm×72 μm of the surface having the ruggedness a mean plane of the ruggedness is a reference plane, a value (S/N) of an area(S) of the region at a height of less than 50 nm from the reference plane divided by a number of convex portions (N) having a height of 50 nm or more from the reference plane is not less than 20.0 μm² and not more than 500.0 μm², and when in a micro region of 5 μm×5 μm of the surface having the ruggedness a cutoff value of a high-pass filter λc is 2.5 μm, an arithmetical mean height Sa is not less than 1.0 nm and not more than 50.0 nm.

A glass member of aspect 3 is the glass member according to aspect 1 or 2, wherein in the region of 96 μm×72 μm of the surface having the ruggedness an average value of heights of tops of the convex portions from the reference plane is preferably not less than 0.10 μm and not more than 5.00 μm.

A glass member of aspect 4 is the glass member according to any one of aspects 1 to 3, wherein when in the micro region of 5 μm×5 μm of the surface having the ruggedness the cutoff value of the high-pass filter λc is 2.5 μm, a skewness Ssk is preferably −0.10 or less.

A glass member of aspect 5 is the glass member according to any one of aspects 1 to 4, wherein a contact angle of water with the surface having the ruggedness of the glass member is preferably 90° or more.

A glass member of aspect 6 is the glass member according to any one of aspects 1 to 5 and may include a glass member body and a water-repellent film provided on a principal surface of the glass member body.

A glass member of aspect 7 is the glass member according to any one of aspects 1 to 5 and may include a glass member body and an optically functional film provided on a principal surface of the glass member body.

A glass member of aspect 8 is the glass member according to aspect 7, wherein the optically functional film is preferably an antireflection film or a reflective film.

### Advantageous Effects of Invention

The present invention enables provision of a glass member having excellent water repellency.

### BRIEF DESCRIPTION OF DRAWINGS

FIG. 1 is a schematic cross-sectional view showing a glass member according to a first embodiment of the present invention.

FIG. 2 is a graph showing a roughness curve in a relatively small region of a first principal surface of the glass member according to the first embodiment of the present invention.

FIG. 3 is a graph showing a roughness curve in a relatively large region of the first principal surface of the glass member according to the first embodiment of the present invention.

FIG. 4 is a schematic cross-sectional view showing a glass member according to a second embodiment of the present invention.

FIG. 5 is a photograph taken when a water drop was placed on a surface of a glass member obtained in Example 2.

FIG. 6 is a photograph taken when a water drop was placed on a surface of a glass member obtained in Comparative Example 1.

FIG. 7 is a photograph taken when a water drop was placed on a surface of a glass member obtained in Comparative Example 2.

### DESCRIPTION OF EMBODIMENTS

Hereinafter, a description will be given of preferred embodiments. However, the following embodiments are merely illustrative and the present invention is not limited to the following embodiments. Throughout the drawings, members having substantially the same functions may be referred to by the same reference characters.

### First Embodiment

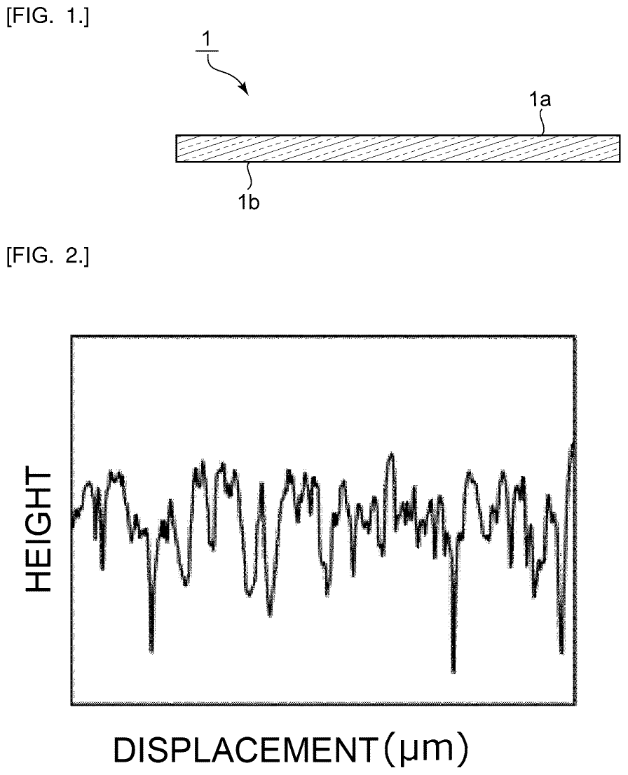

FIG. 1 is a schematic cross-sectional view showing a glass member according to a first embodiment of the present invention.

A glass member 1 has the shape of a rectangular flat plate. However, the shape of the glass member 1 is not particularly limited and may be a flat plate shape of a circular or polygonal profile, a shape in which a flat plate shape is entirely curved, a spherical or aspherical lens shape or so on.

The material for the glass member 1 is not particularly limited and examples include quartz glass, soda-lime glass, alkali-free glass, aluminosilicate glass, borosilicate glass, phosphate glass, fluoride glass, and chalcogenide glass. These materials may be used singly or in a combination of a plurality of them.

The thickness of the glass member 1 is not particularly limited and, for example, may be not less than 50 μm and not more than 100 mm.

The glass member 1 has a first principal surface 1a and a second principal surface 1b opposed to each other. The first principal surface 1a and the second principal surface 1b constitute both surfaces of the glass member 1. In this embodiment, ruggedness is formed over the whole of the first principal surface 1a of the glass member 1.

In the present invention, it is sufficient that ruggedness is formed on at least a portion of the first principal surface 1a of the glass member 1. The ruggedness is preferably provided on 1% or more, more preferably 30% or more, and still more preferably 50% or more of the first principal surface 1a of the glass member 1. As in this embodiment, the ruggedness may be provided over the whole of the first principal surface 1a of the glass member 1. Alternatively, the ruggedness may be provided on the second principal surface 1b of the glass member 1 or may be provided on both the first principal surface 1a and the second principal surface 1b.

In a first invention of the present application, when in a region of 96 μm×72 μm of the first principal surface 1a (hereinafter also referred to simply as the surface) having ruggedness the mean plane of the ruggedness is a reference plane, the number of convex portions (N) having a height of 50 nm or more from the reference plane is not less than 10 and not more than 250. Furthermore, in the first invention, when in a micro region of 5 μm×5 μm of the first principal surface 1a (the surface) having ruggedness the cutoff value of a high-pass filter λc is 2.5 μm, the arithmetical mean height Sa is not less than 1.0 nm and not more than 50.0 nm.

In a second invention of the present application, when in a region of 96 μm×72 μm of the first principal surface 1a (hereinafter also referred to simply as the surface) having ruggedness the mean plane of the ruggedness is a reference plane, the value (S/N) of the area(S) of the region at a height of less than 50 nm from the reference plane divided by the number of convex portions (N) having a height of 50 nm or more from the reference plane is not less than 20.0 μm² and not more than 500.0 μm². Furthermore, when in a micro region of 5 μm×5 μm of the first principal surface 1a (the surface) having ruggedness the cutoff value of a high-pass filter λc is 2.5 μm, the arithmetical mean height Sa is not less than 1.0 nm and not more than 50.0 nm.

In determining the number of convex portions (N) having a height of 50 nm or more from the reference plane, the surface is measured in terms of surface roughness in conformity with ISO 25178 and a mean plane of the ruggedness located at an average height of the ruggedness along a Z direction thereof is defined as the reference plane. Then, the measured data is binarized with respect to the height of 50 nm from the reference plane assumed as a threshold and each independent region having a height equal to or greater than the threshold is assumed as a single bump. From the number of these independent regions having a height equal to or greater than the threshold, the above number of convex portions (N) can be determined. The number of convex portions (N) having a height of 50 nm or more from the reference plane is also referred to simply as the number of convex portions (N).

The area(S) of the region at a height of less than 50 nm from the reference plane is the area thereof exclusive of the area of the convex portions and can be determined by binarizing the measured data with respect to the height of 50 nm from the reference plane assumed as a threshold, determining the area of the convex portions from the sum of projected areas of regions having a height equal to or greater than the threshold, and subtracting the area of the convex portions from the total area. The area(S) of the region at a height of less than 50 nm from the reference plane is hereinafter also referred to simply as the projected area(S) exclusive of convex portions. Furthermore, the value (S/N) of the projected area(S) exclusive of convex portions divided by the number of convex portions (N) is also referred to simply as the value (S/N).

The “arithmetical mean height Sa” is a parameter which is defined in ISO 25178 and in which a measured total profile representing a cross-sectional shape of ruggedness is extended to a surface. Specifically, the arithmetical mean height Sa can be determined from the average of absolute values of heights Zn of ruggedness in a predetermined three-dimensional region (Sa=(Σ|Zn|)/n). In the present invention, the arithmetical mean height Sa is obtained by performing the measurement in a region of 5 μm×5 μm and setting the cutoff value of the high-pass filter λc at 2.5 μm.

Hereinafter, the first invention and the second invention may be referred to collectively as the present invention. The first invention and the second invention may be implemented singly or in combination.

Since the glass member 1 according to this embodiment has the above structure of the present invention, it has excellent water repellency even without any water-repellent coating being formed on the surface. In the present invention, a water-repellent coating may not be formed or a water-repellent coating may be provided as in a second embodiment to be described hereinafter.

It is heretofore known that when ruggedness is formed on the surface of a solid, the tendency of wettability of the solid surface with water varies widely depending on whether the solid is hydrophilic or water repellent.

Specifically, the Wenzel model explains that hydrophilic solids are further increased in hydrophilicity by the formation of ruggedness on the solid surfaces, whereas water repellent solids are further increased in water repellency by the formation of ruggedness on the solid surfaces.

In this relation, the surface of the glass member is hydrophilic. Therefore, if ruggedness is formed on its surface, its hydrophilicity will be further increased.

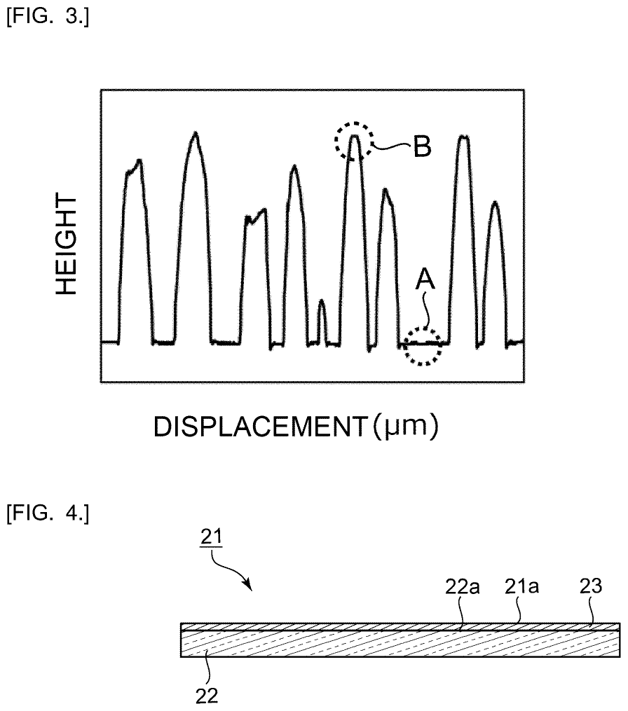

In these conditions, the inventors focused on both a roughness curve in a relatively small region of the first principal surface 1a (the surface) of the glass member 1 and a roughness curve in a relatively large region of the first principal surface 1a (the surface) of the glass member 1. The roughness curve in a relatively small region of the surface of the glass member 1 is represented, for example, as a roughness curve as shown in FIG. 2. On the other hand, the roughness curve in a relatively large region of the surface of the glass member 1 is represented, for example, as a roughness curve as shown in FIG. 3. The roughness curves in FIGS. 2 and 3 are schematic roughness curves given for illustration and the portion enclosed by the broken line A in FIG. 3 corresponds to the roughness curve in FIG. 2.

Specifically, the inventors found in the first invention that, surprisingly, when the number of convex portions (N) in a relatively large region (a region of 96 μm×72 μm) of the surface of the glass member 1 and the arithmetical mean height Sa in a relatively small region (a region of 5 μm×5 μm) of the surface of the glass member 1 are adjusted within respective specific ranges, the water repellency of the surface of the glass member 1 can be increased.

The reason for the above can be understood as follows. It can be thought that when the number of convex portions (N) in the surface of the glass member 1 is not less than 10 and not more than 250 and the arithmetical mean height Sa in the surface of the glass member 1 is not less than 1.0 nm and not more than 50.0 nm, more air layer is held in the depressions of the ruggedness on the surface of the glass member 1, thus decreasing the wettability of the surface. It can be thought that, as these results, the water repellency of the surface of the glass member 1 can be increased.

In the first invention, the number of convex portions (N) on the surface of the glass member 1 is preferably not less than 15, more preferably not less than 20, further more preferably not less than 25, still further more preferably not less than 30, yet still further more preferably not less than 40, even yet still further more preferably not less than 50, particularly preferably not less than 100, most preferably not less than 150, preferably not more than 245, more preferably not more than 240, further more preferably not more than 235, particularly preferably not more than 230, and most preferably not more than 225.

When the number of convex portions (N) on the surface of the glass member 1 is the above lower limit or more, liquid can be made even less likely to enter the depressions of the ruggedness on the surface of the glass member 1 and, thus, the air layer can be even more certainly held in the depressions. Therefore, the water repellency can be even further increased. When the number of convex portions (N) on the surface of the glass member 1 is the above upper limit or less, the air layer can be even more certainly held in the depressions of the ruggedness on the surface of the glass member 1. Therefore, the water repellency can be even further increased.

Furthermore, in the first invention, when in a region of 96 μm×72 μm of the surface having ruggedness of the glass member 1 the mean plane of the ruggedness is a reference plane, the number of convex portions (N2) having a height of 100 nm or more from the reference plane is preferably not less than 15, more preferably not less than 20, further more preferably not less than 30, preferably not more than 245, more preferably not more than 235, and further more preferably 225. The number of convex portions (N2) can be determined in the same manner as for the above-described number of convex portions (N) except that the height from the reference plane is 100 nm or more.

When the number of convex portions (N2) on the surface of the glass member 1 is the above lower limit or more, liquid can be made even less likely to enter the depressions of the ruggedness on the surface of the glass member 1 and, thus, the air layer can be even more certainly held in the depressions. Therefore, the water repellency can be even further increased. When the number of convex portions (N2) on the surface of the glass member 1 is the above upper limit or less, the air layer can be even more certainly held in the depressions of the ruggedness on the surface of the glass member 1. Therefore, the water repellency can be even further increased.

Furthermore, in the first invention, a percentage change ((|N−N2|/N)×100), which is a value in percentage terms of an absolute value of a difference between the above number of convex portions (N) and the above number of convex portions (N2) divided by the number of convex portions (N), is preferably not more than 50%, more preferably not more than 25%, and further more preferably not more than 10%. The lower limit of the percentage change ((|N−N2|/N)×100) is not particularly limited, but may be not less than 0.1% or not less than 1%.

When the percentage change ((|N−N2|/N)×100) is the above upper limit or less, the convex portions on the surface of the glass member 1 are more uniform in height. Therefore, liquid can be made even less likely to enter between the convex portions on the surface of the glass member 1 and, thus, the air layer can be even more certainly held on the surface. Therefore, the water repellency can be even further increased.

Furthermore, the inventors found in the second invention that, surprisingly, also when the value (S/N) in a relatively large region (a region of 96 μm×72 μm) of the surface of the glass member 1 and the arithmetical mean height Sa in a relatively small region (a region of 5 μm×5 μm) of the first principal surface 1a of the glass member 1 are adjusted within respective specific ranges, the water repellency of the surface of the glass member 1 can be increased.

The reason for the above can be understood as follows. It can be thought that when the value (S/N) in the surface of the glass member 1 is not less than 20.0 μm² and not more than 500.0 μm² and the arithmetical mean height Sa in the surface of the glass member 1 is not less than 1.0 nm and not more than 50.0 nm, more air layer is held in the depressions of the ruggedness on the surface of the glass member 1, thus decreasing the wettability of the surface. It can be thought that, as these results, the water repellency of the surface of the glass member 1 can be increased.

In the second invention, the value (S/N) in the surface of the glass member 1 is preferably not less than 21.0 μm², more preferably not less than 22.0 μm², further more preferably not less than 23.0 μm², still further more preferably not less than 24.0 μm², yet still further more preferably not less than 25.0 μm², even yet still further more preferably not less than 30.0 μm², even yet still further more preferably 40.0 μm², even yet still further more preferably not less than 50.0 μm², even yet still further more preferably not less than 70.0 μm², particularly preferably not less than 100.0 μm², most preferably not less than 150.0 μm², preferably not more than 400.0 μm², more preferably not more than 350.0 μm², further more preferably not more than 300.0 μm², particularly preferably not more than 250.0 μm², and most preferably not more than 230.0 μm².

When the value (S/N) in the surface of the glass member 1 is the above lower limit or more, more air layer can be held in the depressions of the ruggedness on the surface of the glass member 1. Therefore, the water repellency can be even further increased.

When the value (S/N) in the surface of the glass member 1 is the above upper limit or less, liquid can be made even less likely to enter the depressions of the ruggedness on the surface of the glass member 1 and, thus, the air layer can be even more certainly held in the depressions. Therefore, the water repellency can be even further increased.

Therefore, when the value (S/N) in the surface of the glass member 1 is within the above range, the water repellency of the surface of the glass member 1 can be further increased.

In the present invention, the arithmetical mean height Sa in the surface of the glass member 1 is preferably not less than 2.0 nm, more preferably not less than 3.0 nm, further more preferably not less than 4.0 nm, particularly preferably not less than 5.0 nm, most preferably not less than 6.0 nm, preferably not more than 45.0 nm, more preferably not more than 40.0 nm, further more preferably not more than 35.0 nm, particularly preferably not more than 30.0 nm, and most preferably not more than 25.0 nm.

When the arithmetical mean height Sa in the surface of the glass member 1 is the above lower limit or more, more air layer can be held in the depressions of the ruggedness on the surface of the glass member 1. Therefore, the water repellency can be even further increased. When the arithmetical mean height Sa in the surface of the glass member 1 is the above upper limit or less, liquid can be made even less likely to enter the depressions of the ruggedness on the surface of the glass member 1 and, thus, the air layer can be even more certainly held in the depressions. Therefore, the water repellency can be even further increased. In addition, when the arithmetical mean height Sa in the surface of the glass member 1 is the above upper limit or less, light scattering due to the shape of ruggedness can be made even less likely to occur and, thus, the clearness of the surface of the glass member 1 can be even less likely to be impaired.

In the present invention, when in a region of 5 μm×5 μm located below the above reference plane the cutoff value of a high-pass filter λc is 2.5 μm, the arithmetical mean height SaA is preferably not less than 1.0 nm, more preferably not less than 2.0 nm, further more preferably not less than 3.0 nm, still further more preferably not less than 4.0 nm, particularly preferably not less than 5.0 nm, most preferably not less than 6.0 nm, preferably not more than 50.0 nm, more preferably not more than 45.0 nm, further more preferably not more than 40.0 nm, still further more preferably not more than 35.0 nm, particularly preferably not more than 30.0 nm, and most preferably not more than 25.0 nm.

The arithmetical mean height SaA can be measured, like the “arithmetical mean height Sa”, in conformity with ISO 25178. Specifically, the arithmetical mean height SaA can be determined by measuring the arithmetical mean height in a micro region located below the above reference plane as shown by the broken line A in FIG. 3.

When the arithmetical mean height SaA in the surface of the glass member 1 is the above lower limit or more, more air layer can be held in the depressions of the ruggedness on the surface of the glass member 1. Therefore, the water repellency can be even further increased. When the arithmetical mean height SaA in the surface of the glass member 1 is the above upper limit or less, liquid can be made even less likely to enter the depressions of the ruggedness on the surface of the glass member 1 and, thus, the air layer can be even more certainly held in the depressions. Therefore, the water repellency can be even further increased. In addition, when the arithmetical mean height SaA in the surface of the glass member 1 is the above upper limit or less, light scattering due to the shape of ruggedness can be made even less likely to occur and, thus, the clearness of the surface of the glass member 1 can be even less likely to be impaired.

In the present invention, when, in a region of 5 μm×5 μm being a top portion of a bump having a height of 50 nm or more from the above reference plane, the cutoff value of a high-pass filter λc is 2.5 μm, the arithmetical mean height SaB is preferably not less than 1.0 nm, more preferably not less than 2.0 nm, further more preferably not less than 3.0 nm, still further more preferably not less than 4.0 nm, particularly preferably not less than 5.0 nm, most preferably not less than 6.0 nm, preferably not more than 50.0 nm, more preferably not more than 45.0 nm, further more preferably not more than 40.0 nm, still further more preferably not more than 35.0 nm, particularly preferably not more than 30.0 nm, and most preferably not more than 25.0 nm. The arithmetical mean height SaB can be measured, like the “arithmetical mean height Sa”, in conformity with ISO 25178. Specifically, the arithmetical mean height SaB can be determined by measuring the arithmetical mean height in a micro region being a top portion of a bump having a height of 50 nm or more from the above reference plane as shown by the broken line B in FIG. 3.

When the arithmetical mean height SaB in the surface of the glass member 1 is the above lower limit or more, more air layer can be held in the depressions of the ruggedness on the surface of the glass member 1. Therefore, the water repellency can be even further increased. When the arithmetical mean height SaB in the surface of the glass member 1 is the above upper limit or less, liquid can be made even less likely to enter the depressions of the ruggedness on the surface of the glass member 1 and, thus, the air layer can be even more certainly held in the depressions. Therefore, the water repellency can be even further increased. In addition, when the arithmetical mean height SaB in the surface of the glass member 1 is the above upper limit or less, light scattering due to the shape of ruggedness can be made even less likely to occur and, thus, the clearness of the surface of the glass member 1 can be even less likely to be impaired.

Although in the present invention the arithmetical mean height SaA in a micro region (the region shown by the broken line A in FIG. 3) located below the above reference plane is adopted as the arithmetical mean height Sa, the arithmetical mean height SaB in a micro region being a top portion of a bump having a height of 50 nm or more from the above reference plane may be adopted as the arithmetical mean height Sa or the average value of the arithmetical mean height SaA and the arithmetical mean height SaB may be adopted as the arithmetical mean height Sa.

If, in measuring the arithmetical mean height SaA and the arithmetical mean height SaB, a region of 5 μm×5 μm cannot be secured as a region for the measurement (for example, there is no bump region having an area of 5 μm×5 μm or more) or a boundary between a bump and a depression is contained in a region for the measurement, the measured values in these cases are not adopted. Furthermore, if, in the measurement of the arithmetical mean height Sa, one of the arithmetical mean height SaA and the arithmetical mean height SaB cannot be measured, the value that can be measured is adopted.

In the present invention, in the case where both the arithmetical mean height SaA and the arithmetical mean height SaB can be measured, the absolute value of (SaA-SaB)/Sa is preferably not more than 0.2, more preferably not more than 0.1, and further more preferably not more than 0.05. The lower limit of the absolute value of (SaA-SaB)/Sa is not particularly limited and may be not less than 0 or not less than 0.01. When the absolute value of (SaA-SaB)/Sa is the above upper limit or less, homogeneous water repellency can be easily obtained.

In the present invention, the average value of the heights at the tops of convex portions from the above reference plane in a region of 96 μm×72 μm of the surface of the glass member 1 is preferably not less than 0.07 μm, more preferably not less than 0.10 μm, further more preferably not less than 0.12 μm, particularly preferably not less than 0.15 μm, most preferably not less than 0.20 μm, preferably not more than 5.00 μm, more preferably not more than 4.50 μm, further more preferably not more than 4.00 μm, particularly preferably not more than 3.00 μm, and most preferably not more than 2.50 μm.

The heights at the tops of convex portions from the above reference plane are the respective maximum heights of the individual convex portions from the above reference plane (a height of 0.0 μm). The average value of the heights at the tops of convex portions from the above reference plane (hereinafter, referred to also as the heights of bump tops) is a value obtained by calculating the heights of bump tops from all the convex portions having a height of 50 nm or more from the above reference plane in a region of 96 μm×72 μm of the first principal surface 1a of the glass member 1 and averaging the calculated heights.

When the average value of the heights of bump tops in the surface of the glass member 1 is the above lower limit or more, liquid can be made even less likely to enter the depressions of the ruggedness on the surface of the glass member 1 and, thus, the air layer can be even more certainly held in the depressions. Therefore, the water repellency can be further increased. In addition, when the average value of the heights of bump tops in the surface of the glass member 1 is the above upper limit or less, light scattering due to the shape of ruggedness can be made even less likely to occur and, thus, the clearness of the surface of the glass member 1 can be even less likely to be impaired.

Therefore, when the average value of the heights of bump tops in the surface of the glass member 1 is within the above range, the water repellency of the surface of the glass member 1 can be further increased and the clearness of the surface of the glass member 1 can be even less likely to be impaired.

In the present invention, when in a micro region of 5 μm×5 μm of the surface of the glass member 1 the cutoff value of a high-pass filter λc is 2.5 μm, the skewness Ssk is preferably not more than −0.10, more preferably not more than −0.20, and further more preferably not more than −0.30. The skewness Ssk can be measured in conformity with ISO 25178.

When the skewness Ssk in the surface of the glass member 1 is the above upper limit or less, the histogram of heights of the shape of ruggedness is distributed more heavily toward upper side and, therefore, a steeper shape of ruggedness having deep depressions relative to convex portions is formed. As a result, the air layer held in the depressions can be less likely to be displaced by liquid and can be more easily held therein, and, thus, the water repellency of the surface of the glass member 1 can be further increased.

The lower limit of the skewness Ssk in the surface of the glass member 1 is not particularly limited, but may be, for example, −10.

In the present invention, when in a micro region of 5 μm×5 μm located below the above reference plane the cutoff value of a high-pass filter λc is 2.5 μm, the skewness SskA is preferably not more than −0.10, more preferably not more than −0.20, and further more preferably not more than −0.30. The skewness SskA can be measured, like the “skewness Ssk”, in conformity with ISO 25178. Specifically, the skewness SskA can be determined by measuring the skewness in a micro region located below the above reference plane as shown by the broken line A in FIG. 3.

When the skewness SskA in the surface of the glass member 1 is the above upper limit or less, the air layer can be even more easily held on the surface and the water repellency of the surface of the glass member 1 can be further increased.

The lower limit of the skewness SskA in the surface of the glass member 1 is not particularly limited, but may be, for example, −10.

In the present invention, when, in a micro region of 5 μm×5 μm being a top portion of a bump having a height of 50 nm or more from the above reference plane, the cutoff value of a high-pass filter λc is 2.5 μm, the skewness SskB is preferably not more than −0.10, more preferably not more than −0.20, and further more preferably not more than −0.30. The skewness SskB can be measured, like the “skewness Ssk”, in conformity with ISO 25178. Specifically, the skewness SskB can be determined by measuring the skewness in a micro region being a top portion of a bump having a height of 50 nm or more from the above reference plane as shown by the broken line B in FIG. 3.

When the skewness SskB in the surface of the glass member 1 is the above upper limit or less, the air layer can be even more easily held on the surface and the water repellency of the surface of the glass member 1 can be further increased.

The lower limit of the skewness SskB in the surface of the glass member 1 is not particularly limited, but may be, for example, −10.

In the present invention, either the skewness SskA or the skewness SskB may be adopted as the skewness Ssk or the average value of the skewness SskA and the skewness SskB may be adopted as the skewness Ssk.

If, in measuring the skewness SskA and the skewness SskB, a region of 5 μm×5 μm cannot be secured as a region for the measurement (for example, there is no bump region having an area of 5 μm×5 μm) or a boundary between a bump and a depression is contained in a region for the measurement, the measured values in these cases are not adopted. Furthermore, if, in the measurement of the skewness Ssk, one of the skewness SskA and the skewness SskB cannot be measured, the value that can be measured is adopted.

Herein, the term “water repellent” means that the contact angle represented by, of both the angles formed between the tangent to a liquid surface and a solid surface, the angle including the liquid is 90° or greater.

Specifically, the contact angle of water with the surface of the glass member 1 is not less than 90°, preferably not less than 93°, more preferably not less than 95°, further more preferably not less than 97°, and particularly preferably not less than 100°. In this case, the water repellency of the surface of the glass member 1 can be further increased. The upper limit of the contact angle of water with the surface of the glass member 1 is not particularly limited and may be, for example, 180°.

The contact angle (0) on the surface of the glass member 1 can be measured based on the sessile drop method (half-angle fitting method) defined in JIS R 3257:1999. For example, in this embodiment, the contact angle can be measured by placing the glass member 1 horizontally with the first principal surface 1a facing up, putting a drop of 2 μL of pure water on the first principal surface 1a, and taking a photograph of the water drop edge-on with a digital scope (product name: “VHX-500F” manufactured by Keyence Corporation).

In the present invention, the haze of the glass member 1 can be arbitrarily selected depending on desired properties or purposes. For example, when the clearness should be more certainly ensured, the haze of the glass member 1 is preferably less than 90%, more preferably not more than 80%, further more preferably not more than 70%, still further more preferably not more than 60%, yet still further more preferably not more than 50%, even yet still further more preferably not more than 40%, even yet still further more preferably not more than 30%, and even yet still further more preferably not more than 20%. On the other hand, from the viewpoint of more certainly suppressing reflection, the haze of the glass member 1 is preferably not less than 3%, more preferably not less than 5%, further more preferably not less than 10%, still further more preferably not less than 15%, yet still further more preferably not less than 20%, even yet still further more preferably not less than 25%, even yet still further more preferably not less than 30%, and even yet still further more preferably not less than 35%.

Since the glass member 1 according to this embodiment has excellent water repellency, it can be suitably used as lens members and cover members of cameras for use outdoors, including vehicle-mounted cameras and monitoring cameras. In addition, the glass member 1 according to this embodiment can also be suitably used as window panel members of motor vehicles, railway vehicles, ships, airplanes, and so on.

### (Manufacturing Method)

Next, a description will be given of an example of the method for manufacturing the glass member 1.

Ruggedness on the first principal surface 1a of the glass member 1 are formed by subjecting a surface of an original glass member to a chemical etching treatment and then subjecting it to a wet blasting treatment.

The chemical etching treatment is a treatment in which an original glass member is immersed into an etching liquid, such as hydrofluoric acid, to form ruggedness thereon. By the chemical etching treatment, the number of convex portions (N) and the value (S/N) in the surface of the resulting glass member 1 can be adjusted.

In the chemical etching treatment, the composition of the etching liquid may be, for example, a mixture solution containing hydrofluoric acid and ammonium fluoride, a mixture solution containing hydrofluoric acid and potassium hydrogen fluoride, or a mixture solution containing hydrofluoric acid and sodium hydrogen fluoride. The etching liquid may contain any other acid, such as sulfuric acid, nitric acid or hydrochloric acid, or a chelating agent, such as citric acid or ethylenediamine tetraacetic acid.

The content of hydrofluoric acid in the etching liquid may be, for example, not less than 0.1% by mass and not more than 50% by mass. The content of ammonium fluoride in the etching liquid may be, for example, not less than 1% by mass and not more than 40% by mass. The content of potassium hydrogen fluoride in the etching liquid may be, for example, not less than 1% by mass and not more than 40% by mass. The content of sodium hydrogen fluoride in the etching liquid may be, for example, not less than 1% by mass and not more than 40% by mass. Furthermore, the content of water in the etching liquid may be, for example, not less than 10% by mass and not more than 98.9% by mass.

The treatment temperature in the chemical etching treatment may be, for example, not lower than 10° C. and not higher than 50° C. The treatment time for the chemical etching treatment may be, for example, not shorter than 1 second and not longer than three hours.

The number of convex portions (N) and the value (S/N) can be adjusted by the composition of the etching liquid, the treatment time, the treatment temperature, and so on in the chemical etching treatment. Specifically, the number of convex portions (N) can be increased by increasing the content of ammonium fluoride, potassium hydrogen fluoride or sodium hydrogen fluoride in the etching liquid or increasing the treatment temperature with the etching liquid.

More specifically, when the content of ammonium fluoride, potassium hydrogen fluoride or sodium hydrogen fluoride in the etching liquid is increased or the treatment temperature with the etching liquid is increased, the number of convex portions (N) etch-formed on the surface subjected to the same depth to the etching treatment tends to increase and the projected area(S) exclusive of convex portions tends to decrease (i.e., the area of the convex portions tends to increase), compared to when they are not increased. If the projected area(S) exclusive of convex portions further decreases (the area of the convex portions further increases), adjacent convex portions tend to adhere to each other, thus decreasing the number of convex portions (N). On the other hand, when the content of hydrofluoric acid in the etching liquid is increased or the treatment time for etching is simply increased, the area of convex portions formed by etching increases and the projected area(S) exclusive of convex portions decreases. The number of convex portions (N) and the projected area(S) exclusive of convex portions are determined by a balance among these treatment conditions.

The wet blasting treatment is a treatment in which a slurry obtained by homogeneously stirring abrasive particles composed of alumina particles or other solid particles and water or other liquids is sprayed onto a workpiece formed of an original glass member from a spray nozzle at high speed using compressed air to form fine ruggedness on the workpiece.

In the wet blasting treatment, when the slurry sprayed at high speed impinges on the workpiece, the abrasive particles in the slurry grind, strike, and scrape the surface of the workpiece and, thus, fine ruggedness is formed on the surface of the workpiece.

In this case, the abrasive particles shot onto the workpiece and fragments of the workpiece ground by the abrasive particles are flushed out with the liquid sprayed onto the workpiece and, therefore, the amount of particles remaining on the workpiece is small.

In the case of the wet blasting treatment, the liquid carries the abrasive particles to the workpiece upon spraying of the slurry onto the workpiece. Therefore, as compared to dry sandblasting treatment, fine abrasive particles can be easily used and the shock at the time of impingement of the abrasive particles on the workpiece is small, which enables the workpiece to be precisely processed.

In the wet blasting treatment, the average particle diameter of the abrasive particles may be, for example, not less than 0.2 μm and not more than 60 μm. The air pressure during spraying of the slurry containing abrasive particles may be, for example, not less than 0.1 MPa and not more than 0.5 MPa. The scanning speed of the nozzle may be, for example, not less than 0.1 mm/s and not more than 100 mm/s. The average particle diameter of the abrasive particles can be measured, for example, by the electrical resistance method.

Furthermore, the arithmetical mean height Sa in the surface of the glass member 1 can be increased by, in the wet blasting treatment, increasing the average particle diameter of the abrasive particles, increasing the slurry injection pressure or decreasing the scanning speed of the nozzle.

The original glass member may be subjected to, prior to the chemical etching treatment, a first wet blasting treatment to give it ruggedness serving as initiation sites of etching and further subjected to, after the chemical etching treatment, a second wet blasting treatment.

By subjecting the workpiece (the original glass member) to the chemical etching treatment and the wet blasting treatment in the above manners, the shape of ruggedness with appropriate sizes can be formed on the surface of the glass member 1. Thus, the water repellency of the surface of the glass member 1 can be increased without impairing the clearness of the glass member 1.

### Second Embodiment

FIG. 4 is a schematic cross-sectional view showing a glass member according to a second embodiment of the present invention. As shown in FIG. 4, a glass member 21 includes a glass member body 22 and a functional film 23. The functional film 23 is provided on a principal surface 22a of the glass member body 22.

In this embodiment, similar ruggedness to those on the first principal surface 1a of the glass member 1 according to the first embodiment are formed on a principal surface 21a of the glass member 21 (i.e., a principal surface of the functional film 23). In forming the functional film 23 on the principal surface 22a of the glass member body 22 as just described, it is sufficient to previously form the shape of ruggedness on the principal surface 22a of the glass member body 22 so that the shape of ruggedness on the principal surface of the formed functional film 23 (the principal surface 21a) has a similar shape of ruggedness to that on the principal surface 1a of the glass member 1 according to the first embodiment. Alternatively, the ruggedness may be formed after the formation of the functional film 23. In doing so, the functional film 23 is preferably formed thicker than the shape of ruggedness to be formed.

For example, a water-repellent film can be used as the functional film 23. In this embodiment, similar ruggedness to those on the first principal surface 1a of the glass member 1 according to the first embodiment are formed on the principal surface 21a of the glass member 21 (i.e., the principal surface of the functional film 23). Therefore, even if the water-repellent film is worn or detached by friction due to rubbing or so on, the principal surface 21a can be given high water repellency by the ruggedness. Therefore, the glass member can maintain high water repellency over a long period of time.

An organic thin film or like films for increasing the water repellency can be used as the water-repellent film. The materials for the organic thin film that can be used include compounds containing a fluorine-modified organic group and a silyl group, and silane compounds containing an alkyl group or a fluoroalkyl group. Specifically, the organic thin film can be formed by binding a silane compound containing an alkyl group or a fluoroalkyl group or the like to the surface of the glass member body 22. The water-repellent film may contain a silicone resin and may be an organic thin film containing, among silicone resins, a methyl silicone resin, a methyl phenyl silicone resin, an alkyd-modified silicone resin, an epoxy-modified silicone resin, an acryl-modified silicone resin, a polyester-modified silicone resin, a fluorine-modified silicone resin or the like.

Alternatively, the functional film 23 may be an optically functional film. For example, an antireflection film or a reflective film can be used as the optically functional film. Examples that can be used as the antireflection film and the reflective film include a low-refractive index film having a lower refractive index than the glass member body 22 and a dielectric multi-layer film in which low-refractive index films having a relatively low refractive index and high-refractive index films having a relatively high refractive index are alternately layered. The antireflection film and the reflective film can be formed by sputtering, CVD or other methods.

The thickness of the functional film 23 is not particularly limited without impairing the above effects of the invention, but may be, for example, not less than 1 nm and not more than 5 μm.

The rest is the same as in the first embodiment. Since the glass member 21 according to this embodiment has the above structure of the present invention, it has excellent water repellency.

Hereinafter, a description will be given in further detail of the present invention with reference to specific examples. The present invention is not at all limited by the following examples and modifications and variations may be appropriately made therein without changing the gist of the invention.

### Examples 1 to 10

In Examples 1 to 10 (Ex. 1 to Ex. 10), first, a 0.5 mm thick sheet of aluminosilicate glass (product name: “T2X-1” manufactured by Nippon Electric Glass Co., Ltd.) having the shape of a rectangular plate was prepared.

Next, one of the principal surfaces of the prepared sheet of aluminosilicate glass (hereinafter, also referred to simply as the glass) was entirely subjected to a chemical etching treatment. Next, the one principal surface of the glass subjected to the chemical etching treatment was subjected to a wet blasting treatment, thus producing a glass member.

In the chemical etching treatment, the glass was subjected to the chemical etching treatment by using an etching liquid prepared to have a content of hydrofluoric acid of 1.6% by mass to 6.0% by mass, a content of ammonium fluoride of 20.0% by mass to 38.7% by mass, and a content of water of 59.7% by mass to 75.0% by mass and immersing the glass into the etching liquid under conditions at a liquid temperature of 20° C. to 40° C. for a treatment time of 0.5 minutes to 10 minutes.

In the wet blasting treatment, a slurry was first prepared by using abrasive particles made of alumina and having an average particle diameter of 1.2 μm or 2.0 μm and homogeneously stirring the abrasive particles with water. Next, the whole of the one principal surface of each glass was subjected to the wet blasting treatment by spraying the prepared slurry onto the whole one principal surface. The spraying of the slurry was conducted by scanning the principal surface with the nozzle while moving the nozzle at a scanning speed of 10 mm/s and spraying the prepared slurry from the nozzle at an air pressure of 0.1 MPa to 0.3 MPa.

In the above manner, a glass member with a surface having ruggedness was produced. The conditions for production of the glass members in Examples 1 to 10 are shown in Tables 1 and 2 below.

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| Chemical | hydrofluoric acid | [% by mass] | 6.0 | 6.0 | 6.0 | 6.0 | 1.6 | 1.6 | 6.0 |
| Etching | ammonium fluoride | [% by mass] | 30.0 | 30.0 | 30.0 | 30.0 | 38.7 | 38.7 | 30.0 |
| Treatment | water | [% by mass] | 64.0 | 64.0 | 64.0 | 64.0 | 59.7 | 59.7 | 64.0 |
| | Treatment | [° C.] | 20 | 40 | 30 | 20 | 40 | 20 | 30 |
| | Temperature | | | | | | | | |
| | Treatment Time | [min.] | 1.0 | 3.0 | 3.0 | 5.0 | 10.0 | 10.0 | 3.0 |
| Wet | Average Particle | [μm] | 1.2 | 1.2 | 1.2 | 1.2 | 1.2 | 1.2 | 1.2 |
| Blasting | Diameter of | | | | | | | | |
| Treatment | Abrasive Particles | | | | | | | | |
| | Scanning Speed | [mm/s] | 10 | 10 | 10 | 10 | 10 | 10 | 10 |
| | Air Pressure | [MPa] | 0.2 | 0.2 | 0.2 | 0.2 | 0.2 | 0.2 | 0.1 |

TABLE 2

| | | | | | | Comp. | Comp. | Comp. | Comp. |
|---|---|---|---|---|---|---|---|---|---|
| | | | Ex. 8 | Ex. 9 | Ex. 10 | Ex. 1 | Ex. 2 | Ex. 3 | Ex. 4 |
| Chemical | hydrofluoric acid | [% by mass] | 6.0 | 5.0 | 5.0 | 6.0 | — | — | — |
| Etching | ammonium fluoride | [% by mass] | 30.0 | 20.0 | 20.0 | 30.0 | — | — | — |
| Treatment | hydrochloric acid | [% by mass] | — | — | — | — | — | — | 5 |
| | water | [% by mass] | 64.0 | 75.0 | 75.0 | 64.0 | — | — | 95 |
| | Treatment | [° C.] | 30 | 30 | 30 | 30 | — | — | 80 |
| | Temperature | | | | | | | | |
| | Treatment Time | [min.] | 3.0 | 0.5 | 1.0 | 3.0 | — | — | 4320 |
| Wet | Average Particle | [μm] | 2.0 | 1.2 | 1.2 | — | 1.2 | — | — |
| Blasting | Diameter of | | | | | | | | |
| Treatment | Abrasive Particles | | | | | | | | |
| | Scanning Speed | [mm/s] | 10 | 10 | 10 | — | 10 | — | — |
| | Air Pressure | [MPa] | 0.3 | 0.2 | 0.2 | — | 0.2 | — | — |

### Comparative Example 1

In Comparative Example 1 (CEx. 1), a sheet of glass was subjected to the chemical etching treatment in the same manner as in Example 3, but not subjected to the wet blasting treatment. The rest was conducted in the same manner as in Example 3, thus obtaining a glass member (Table 2).

### Comparative Example 2

In Comparative Example 2 (CEx. 2), the whole of one principal surface of a sheet of glass was subjected to only the wet blasting treatment in the same manner as in Example 1, thus obtaining a glass member. Therefore, in Comparative Example 2, the glass was not subjected to the chemical etching treatment (Table 2).

In the wet blasting treatment, a slurry was first prepared by using abrasive particles made of alumina and having an average particle diameter of 1.2 μm and homogeneously stirring the abrasive particles with water. Next, the whole of the one principal surface of the glass was subjected to the wet blasting treatment by spraying the prepared slurry onto the whole one principal surface. The spraying of the slurry was conducted by scanning the principal surface with a nozzle while moving the nozzle at a scanning speed of 10 mm/s and spraying the prepared slurry from the nozzle at an air pressure of 0.2 MPa.

### Comparative Example 3

In Comparative Example 3 (CEx. 3), a sheet of aluminosilicate glass of the same type as in Example 1 was used as it was without being subjected to the above series of treatments.

### Comparative Example 4

In Comparative Example 4 (CEx. 4), a sheet of glass was subjected to the chemical etching treatment by changing the composition of the etching liquid for use in the chemical etching treatment and the chemical etching treatment conditions as shown in Table 2 above. Therefore, in Comparative Example 4, the glass was not subjected to the wet blasting treatment.

### (Evaluations)

### [Measurement of Surface Shape]

### (Measurement of Convex Portions)

The glass members in Examples 1 to 10 and Comparative Examples 1 to 4 were measured in terms of the surface roughness of their principal surfaces based on ISO 25178. The measurements in terms of surface roughness were made as to each of the principal surfaces having ruggedness formed thereon. These measurements were made with a laser microscope (item number “VK-X250” manufactured by Keyence Corporation).

The measurements for Examples 1 to 10 and Comparative Examples 1 to 4 were made under measurement conditions where, using a 150-power objective lens, the number of data sets acquired reached 2048×1536 in a region of 96 μm×72 μm measurement area. After the gradients of the plane were removed by the least-square method, analysis was performed in a state where noises in the height direction were removed by setting the threshold of the cutoff level in height at 50.

### Number of Convex Portions (N);

The acquired data on the region of 96 μm×72 μm measurement area was binarized, using as a reference plane a mean plane of the ruggedness located at an average height of the ruggedness along a Z direction thereof, with respect to the height of +50 nm from the average value assumed as a threshold and each independent region having a height equal to or greater than the threshold was assumed as a single bump. Regions having a horizontal cross-sectional area of 0.2 μm² or less at the threshold were excluded. The number of convex portions (N) was determined from the number of independent regions having a height equal to or greater than the threshold when the acquired data was binarized with respect to the threshold. Convex portions having a horizontal cross-sectional area of 0.2 μm² or less at the threshold were excluded. In the case where the arithmetical mean height in the relevant measurement area was less than 5.0 nm, the principal surface was assumed to be an asperity-free smooth surface and the number of convex portions was determined to be zero. Likewise, the acquired data was binarized with respect to the height of +100 nm from the average value assumed as a threshold value and the number of convex portions (N2) was determined from the binarized data.

$$Percentage Change ( ( \vert N - N 2 \vert / N ) \times 100 ) ;$$

The percentage change was determined by dividing the absolute value of the difference between the above number of convex portions (N) and the above number of convex portions (N2) by the number of convex portions (N).

### Value (S/N);

The value (S/N) was determined by, in the region of 96 μm×72 μm measurement area, assuming the mean plane of ruggedness as a reference plane and dividing the area(S) of the region at a height of less than 50 nm from the reference plane by the number of convex portions (N) having a height of 50 nm or more from the reference plane. The area(S) of the region at a height of less than 50 nm from the reference plane is the area thereof exclusive of the area of the convex portions and was determined by binarizing the measured data with respect to the height of 50 nm from the reference plane assumed as a threshold, determining the area of the convex portions from the sum of projected areas of regions having a height equal to or greater than the threshold on the binarized data, and subtracting the area of the convex portions from the total area.

### Average Height of Convex Portions;

As for all convex portions having a height of 50 nm or more from the reference plane in the region of 96 μm×72 μm measurement area, the heights of the bump tops from the above reference plane (a height of 0.0 μm), i.e., the respective maximum heights of the convex portions, were determined and the average of the top heights of the convex portions (the average height of the convex portions) was determined from the average value of the respective maximum heights of the convex portions.

### (Arithmetical Mean Height and Skewness)

The principal surfaces of the glass members in Examples 1 to 10 and Comparative Examples 1 to 4 were measured in terms of surface roughness parameters (arithmetical mean height Sa and skewness Ssk) in their respective micro regions. As for these measurements, the arithmetical mean height SaA in a micro region located below the reference plane was measured as the arithmetical mean height Sa and the skewness SskA in the micro region located below the reference plane was measured as the skewness Ssk. The measurements of the surface roughness parameters were made as to each of the principal surfaces having ruggedness formed thereon. Likewise, the arithmetical mean height SaB and the skewness SskB in a micro region being a top portion of a bump having a height of 50 nm or more from the reference plane were measured. These measurements were made with an atomic force microscope (AFM).

Using as the atomic force microscope (AFM) an atomic force microscope (trade name: Dimension Icon (SPM unit) and Nano Scope V (Controller unit), manufactured by Bruker Corporation), the measurements were conducted based on ISO 25178.

Furthermore, the measurements were made under measurement conditions where, using the tapping mode, the scan rate and the number of data sets acquired reached 1 Hz and 512×512, respectively, in a micro region of 5 μm×5 μm measurement area. Analysis was performed in a state where the cutoff value of a high-pass filter λc was set at 2.5 μm.

### [Measurement of Contact Angle θ]

The glass members in Examples 1 to 10 and Comparative Examples 1 to 4 were measured in terms of the contact angle θ of water with their principal surfaces.

The contact angle θ was measured based on the sessile drop method (half-angle fitting method) defined in JIS R 3257:1999. Specifically, the contact angle θ was measured by placing each glass member horizontally in a state where the principal surface having ruggedness formed thereon was turned face-up, putting a drop of 2 μL of pure water on the principal surface, and taking a photograph of the water drop edge-on with a digital scope (product name: “VHX-500F” manufactured by Keyence Corporation).

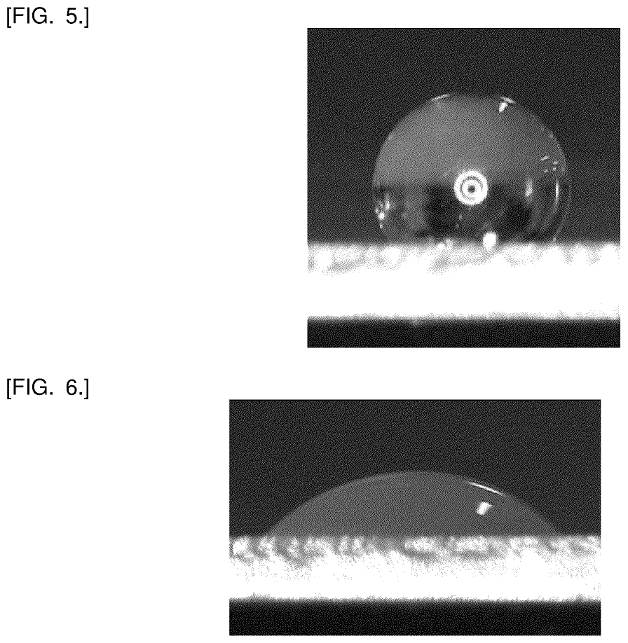

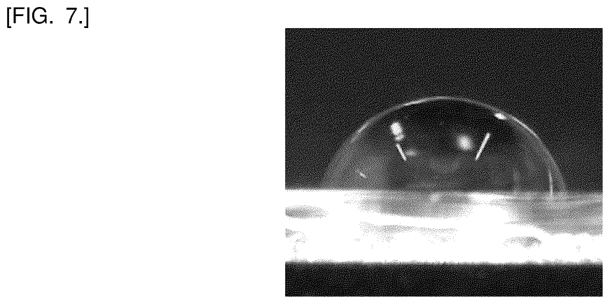

FIG. 5 is a photograph taken when a water drop was placed on a surface of the glass member obtained in Example 2. FIG. 6 is a photograph taken when a water drop was placed on a surface of the glass member obtained in Comparative Example 1 and FIG. 7 is a photograph taken when a water drop was placed on a surface of the glass member obtained in Comparative Example 2.

As shown in FIG. 5, it can be seen that the glass member obtained in Example 2 had a high water repellency (contact angle θ: 120°). On the other hand, as shown in FIGS. 6 and 7, the glass members obtained in Comparative Examples 1 and 2 showed insufficient water repellencies (contact angle θ in Comparative Example 1:47°, contact angle θ in Comparative Example 2: 80°).

### [Measurement of Haze]

Next, the glass members in Examples 1 to 10 and Comparative Examples 1 to 4 were measured in terms of haze. The haze was measured with a ultraviolet-visible-near infrared spectrophotometer (UV-670) manufactured by Shimadzu Corporation and based on JIS K 7361-1-1997.

The results are shown in Tables 3 and 4 below.

TABLE 3

| | | Ex. 1 | Ex. 2 | Ex. 3 | Ex. 4 | Ex. 5 | Ex. 6 | Ex. 7 |
|---|---|---|---|---|---|---|---|---|
| Number of | | 41 | 36 | 58 | 21 | 29 | 25 | 48 |
| Convex Portions (N) | | | | | | | | |
| Number of | | 23 | 39 | 60 | 23 | 31 | 24 | 49 |
| Convex Portions (N2) | | | | | | | | |
| Percentage Change | [%] | 44 | 8 | 3 | 10 | 7 | 4 | 2 |
| ((\|N − N2\|/N) × 100) | | | | | | | | |
| Value (S/N) | [μm²] | 159.6 | 92.2 | 74.0 | 194.3 | 163.4 | 238.4 | 91.5 |
| Average Height of | [μm] | 0.29 | 4.16 | 2.20 | 2.12 | 2.23 | 0.42 | 2.25 |
| Convex Portions | | | | | | | | |
| Arithmetical Mean | [nm] | 8.4 | 11.6 | 12.1 | 10.9 | 9.5 | 10.6 | 3.6 |
| Height Sa | | | | | | | | |
| Skewness Ssk | | −1.10 | −0.75 | −0.40 | −0.49 | −0.54 | −0.89 | −1.60 |
| Arithmetical Mean | [nm] | 8.4 | 11.6 | 12.1 | 10.9 | 9.5 | 10.6 | 3.6 |
| Height SaA | | | | | | | | |
| Skewness SskA | | −1.10 | −0.75 | −0.40 | −0.49 | −0.54 | −0.89 | −1.60 |
| Arithmetical Mean | [nm] | — | 12.0 | 12.5 | 11.3 | 10.2 | 11.0 | 4.2 |
| Height SaB | | | | | | | | |
| Skewness SskB | | — | −0.62 | −0.43 | −0.43 | −0.58 | −0.64 | −1.42 |
| Contact Angle θ | [°] | 99 | 120 | 108 | 108 | 105 | 101 | 104 |
| Haze | [%] | 3.6 | 74.8 | 55.8 | 53.5 | 40.1 | 12.9 | 55.7 |

TABLE 4

| | | | | | Comp. | Comp. | Comp. | Comp. |
|---|---|---|---|---|---|---|---|---|
| | | Ex. 8 | Ex. 9 | Ex. 10 | Ex. 1 | Ex. 2 | Ex. 3 | Ex. 4 |
| Number of | | 66 | 221 | 176 | 60 | 8 | 0 | 2692 |
| Convex Portions (N) | | | | | | | | |
| Number of | | 66 | 206 | 176 | 61 | 1 | 0 | 750 |
| Convex Portions (N2) | | | | | | | | |
| Percentage Change | [%] | 0 | 7 | 0 | 2 | 88 | — | 72 |
| ((\|N − N2\|/N) × 100) | | | | | | | | |
| Value (S/N) | [μm²] | 67.5 | 26.7 | 28.1 | 74.2 | 857.0 | — | 1.7 |
| Average Height of | [μm] | 2.18 | 0.19 | 0.90 | 2.20 | 0.10 | — | 0.22 |
| Convex Portions | | | | | | | | |
| Arithmetical Mean | [nm] | 20.4 | 11.2 | 10.7 | 0.4 | 10.6 | 0.1 | — |
| Height Sa | | | | | | | | |
| Skewness Ssk | | −0.47 | −0.53 | −0.45 | 0.03 | −0.70 | 0.01 | — |
| Arithmetical Mean | [nm] | 20.4 | 11.2 | 10.7 | 0.4 | 10.6 | 0.1 | — |
| Height SaA | | | | | | | | |
| Skewness SskA | | −0.47 | −0.53 | −0.45 | 0.03 | −0.70 | 0.01 | — |
| Arithmetical Mean | [nm] | 19.3 | — | — | 0.5 | — | — | — |
| Height SaB | | | | | | | | |
| Skewness SskB | | −0.55 | — | — | 0.02 | — | — | — |
| Contact Angle θ | [°] | 112 | 100 | 112 | 47 | 80 | 54 | 3 |
| Haze | [%] | 55.9 | 10.0 | 60.7 | 55.7 | 0.5 | 0.1 | 22.5 |

As shown in Tables 3 and 4, the glass members in Examples 1 to 10 showed a contact angle of 99° to 120° and were therefore confirmed to have excellent water repellency.

On the other hand, the glass members in Comparative Examples 1 to 4 showed a contact angle of 3° to 80° and therefore poor results indicating hydrophilicity.

The numbers of convex portions (N) in Examples 1 to 10 were within a range of 21 to 221.

The arithmetical mean heights Sa in Examples 1 to 10 were within a range of 3.6 mm to 20.4 nm. Furthermore, it was confirmed that the arithmetical mean height Sa has a tendency to increase as the average particle diameter of abrasive particles or the air pressure in the wet blasting treatment increases.

The number of convex portions (N) in Comparative Example 1 subjected only to the chemical etching treatment was 60. The arithmetical mean height Sa in Comparative Example 1 was 0.4 nm. Therefore, the arithmetical mean height Sa in Comparative Example 1 was smaller than that in each of Examples 1 to 10.

The number of convex portions (N) and the arithmetical mean height Sa in Comparative Example 2 subjected only to the wet blasting treatment were 8 and 10.6 nm, respectively. Therefore, the number of convex portions (N) in Comparative Example 2 was smaller than that in each of Examples.

The number of convex portions (N) and the arithmetical mean height Sa in Comparative Example 3 not subjected to the series of treatments were 0 and 0.1 nm, respectively. Therefore, the number of convex portions (N) and the arithmetical mean height Sa in Comparative Example 3 not subjected to the series of treatments were smaller than those in each of Examples 1 to 10.

The number of convex portions (N) in Comparative Example 4 in which the composition of the chemical etching liquid was changed was 2692. Therefore, the number of convex portions (N) in Comparative Example 4 was substantially larger than that in each of Examples 1 to 10. The values (S/N) in Examples 1 to 10 were within a range of 26.7 μm² to 238.4 μm².

On the other hand, the value (S/N) in Comparative Example 2 subjected only to the wet blasting treatment was 857.0 μm², which was larger than that in each of Examples 1 to 10. The value (S/N) in Comparative Example 4 in which the composition of the chemical etching liquid was changed was 1.7 μm², which was smaller than that in each of Examples 1 to 10.

The average heights of convex portions in Examples 1 to 10 were within a range of 0.19 μm to 4.16 μm. It was confirmed that the average height of convex portions has a tendency to increase with increasing content of hydrofluoric acid in the etching liquid, increasing temperature during the chemical etching or increasing treatment time for the chemical etching.

On the other hand, the average height of convex portions in Comparative Example 2 subjected only to the wet blasting treatment was 0.10 μm, which was smaller than that in each of Examples.

The skewnesses Ssk in Examples 1 to 10 were within a range of −0.40 to −1.60.

On the other hand, the skewness Ssk in Comparative Example 1 subjected only to the chemical etching treatment and the skewness Ssk in Comparative Example 3 not subjected to the series of treatments were 0.03 and 0.01, respectively.

As seen from the above, it was confirmed that the water repellency of the glass member can be increased by controlling the parameters related to roughness curves of the surface of the glass member.

Particularly, it was confirmed that, in the glass members in Examples 1 to 10 in which the number of convex portions (N) in a region of 96 μm×72 μm was not less than 10 and not more than 250 and the arithmetical mean height Sa in a micro region of 5 μm×5 μm was not less than 1.0 nm and not more than 50.0 nm, the water repellency of the surface could be increased.

### REFERENCE SIGNS LIST

1, 21 . . . glass member
1a, 1b . . . first, second principal surface
21a, 22a . . . principal surface
22 . . . glass member body
23 . . . functional film

1. A glass member with a surface at least partially having ruggedness, wherein
when in a region of 96 μm×72 μm of the surface having the ruggedness a mean plane of the ruggedness is a reference plane, a number of convex portions having a height of 50 nm or more from the reference plane is not less than 10 and not more than 250, and
when in a micro region of 5 μm×5 μm of the surface having the ruggedness a cutoff value of a high-pass filter λc is 2.5 μm, an arithmetical mean height Sa is not less than 1.0 nm and not more than 50.0 nm.

2. A glass member with a surface at least partially having ruggedness, wherein
when in a region of 96 μm×72 μm of the surface having the ruggedness a mean plane of the ruggedness is a reference plane, a value (S/N) of an area(S) of the region at a height of less than 50 nm from the reference plane divided by a number of convex portions (N) having a height of 50 nm or more from the reference plane is not less than 20.0 μm² and not more than 500.0 μm², and
when in a micro region of 5 μm×5 μm of the surface having the ruggedness a cutoff value of a high-pass filter λc is 2.5 μm, an arithmetical mean height Sa is not less than 1.0 nm and not more than 50.0 nm.

3. The glass member according to claim 1, wherein in the region of 96 μm×72 μm of the surface having the ruggedness an average value of heights of tops of the convex portions from the reference plane is not less than 0.10 μm and not more than 5.00 μm.

4. The glass member according to claim 1, wherein when in the micro region of 5 μm×5 μm of the surface having the ruggedness the cutoff value of the high-pass filter λc is 2.5 μm, a skewness Ssk is −0.10 or less.

5. The glass member according to claim 1, wherein a contact angle of water with the surface having the ruggedness of the glass member is 90° or more.

6. The glass member according to claim 1, comprising:
a glass member body; and
a water-repellent film provided on a principal surface of the glass member body.

7. The glass member according to claim 1, comprising:
a glass member body; and
an optically functional film provided on a principal surface of the glass member body.

8. The glass member according to claim 7, wherein the optically functional film is an antireflection film or a reflective film.
